(19) United States
(12) Patent Application Publication
(10) Pub. No.: US 2015/0223432 A1
(43) Pub. Date: Aug. 13, 2015

(54) ADJUSTABLE LEASH FOR PLURALITY OF CANINES

(71) Applicant: Eva Christine LUND, Grantsville, UT (US)

(72) Inventor: Eva Christine LUND, Grantsville, UT (US)

(21) Appl. No.: 14/180,160

(22) Filed: Feb. 13, 2014

(51) Int. Cl. A01K 27/00

(52) U.S. Cl. CPC A01K 27/003

(57) ABSTRACT

A dog leash is disclosed, adapted to facilitate efficient restrain during walking or transport of a plurality of canines The leash comprises a plurality of straps slidably connected to a primary strap for restraining a plurality of dogs.

### BACKGROUND OF THE INVENTION

1. Field of the Invention

This invention relates to dog leashes, and more particularly relates to an implement for walking a plurality of dogs simultaneously.

2. Description of the Related Art

A dog leash is disclosed, adapted to facilitate efficient restrain during walking or transport of a plurality of canines The leash comprises a plurality of straps slidably connected to a primary strap for restraining a plurality of dogs.

Dog leashes are well-known in the art and usually comprise an elongated strap detachably affixable to a dog collar encircling the neck of a canine Dog leashes can also be attached to a harness or halter, and are commonly used for walking and transporting canines, often for pleasure or exercise of the dog owner.

Typically, dog leashes constrain a single canine; however, many dog owners require dog leashes for more than one animal. Implements designed for walking or restraining more than one dog are scarce in the art, and those implements which exist do not allow the leashed animals to move apart from each other along multiple axes.

There is a need in the art for more efficient implements for leashing multiple dogs simultaneously.

### SUMMARY OF THE INVENTION

From the foregoing discussion, it should be apparent that a need exists for an auger rack for vertical auger transport, storage, use and interchange. Beneficially, such an apparatus would overcome many of the difficulties with prior art by providing a safer means for securing, transporting, storing, using and interchanging a plurality of augers by a single operator.

The present invention has been developed in response to the present state of the art, and in particular, in response to the problems and needs in the art that have not yet been fully solved by currently available aparati. Accordingly, the present invention has been developed to provide a leash for restraining a plurality of dogs, the leash comprising: an elongated flexible primary strap comprising a handle at a proximal end and a detachable connector at a distal end for clipping to a dog collar; and one or more elongated flexible slidable straps comprising a d-ring at a proximal end and detachable connector at a distal end for clipping to a dog collar, wherein the d-ring is slidable affixed to the primary strap such that slidable strap slides between the distal and the proximal ends of the primary strap. In some embodiments, each detachable connector comprises a snap shackle. In other embodiments, each detachable connector comprises a swivel clip.

The leash may further comprise one or more dog collars, each collar affixed to one of the primary strap and the slidable strap. In still further embodiments, the leash comprises a d-ring interconnecting the detachable connector and the slidable strap. The primary strap and the slidable strap(s) may each be fabricated from one of leather, polymers, chain, rope, and cable.

A second leash for restraining a plurality of dogs is recited, the leash comprising: an elongated flexible primary strap comprising a handle at a proximal end and a swivel clip at a distal end for clipping to a dog collar; and a plurality of elongated flexible slidable straps, each slidable strap comprising a detachable connector at a proximal end and swivel clip at a distal end for clipping to a dog collar, wherein the d-ring is slidable affixed to the primary strap such that slidable strap slides between the distal and the proximal ends of the primary strap; wherein each slidable strap is detachable from the primary strap.

The leash may further comprising a plurality of dog collars, each collar affixed to one of the primary strap and a slidable strap. The primary strap and the slidable strap(s) each may be fabricated from one of leather, polymers, chain, rope, and cable.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is an elevational perspective view of an adjustable leash for a plurality of canines in accordance with the present invention;

FIG. 2 is an environmental perspective view of an adjustable leash for a plurality of canines in accordance with the present invention; and

FIG. 3 is an elevational perspective view of an adjustable leash for a plurality of canines in accordance with the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

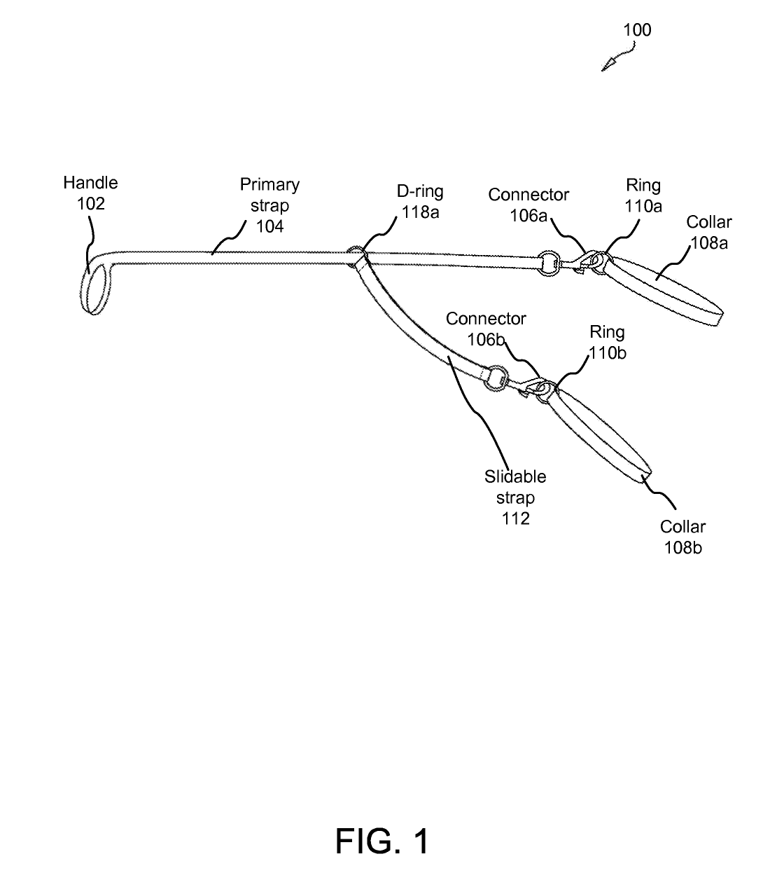

FIG. 1 is an elevational perspective view of an adjustable leash 100 for a plurality of canines in accordance with the present invention. The leash 100 comprises a handle 102, a primary strap 104, a connector 106, a collar 108a, a collar 108b, a ring 110a, a ring 110b, and a slidable strap 112.

The primary strap 104 comprises any elongated flexible strap as well-known to those of skill in the art. The primary strap 104 may be fabricated from nylon, elastic, fibrous materials, leather, chain, rope, cable or the like. The primary strap 104 may be as short as one foot in length up to one hundred feet in length.

The primary strap 104 has a proximal end, which comprises and/or is affixed to, a handle 102. The primary strap 104 also has a distal end which is affixed to a d-ring, a ring, and/or a connector 106 for detachably affixing a collar 108.

The connector 106 may comprise a swivel clip, a snap shackle, a knot, a d-ring, a carribeaner, buckle, or the like. The some embodiments, the connector 106 swivels, or rotates axially, around the length of the primary strap 104.

Like the primary strap 104, the slidable strap 112 also comprises an elongated flexible strap, which may be manufactured or comprise leather, organic, or inorganic materials in addition to those described above.

The slidable strap 112 is connected to the primary strap 104 with a d-ring 118a. In other embodiments, the slidable strap 112 is slidable along the length of the primary strap 104 using other connection means, including a snap swivel, a swivel clip, a knot, buckle or the like.

Each of the primary strap 104 and the slidable strap 112 are connected to collars 108 directly or indirectly. Animals restrained by the leash 100 move not just laterally with respect to one another, but also longitudinally across the length of the primary strap 104.

The handle 102 may comprise any handle known to those of skill in the art, including a loop. The handle 102 may be fabricated of the same or differing material(s) than the primary strap 104.

In various embodiments, the handle 102 clips to a belt, glove, or harness worn by an operator of the leash 100.

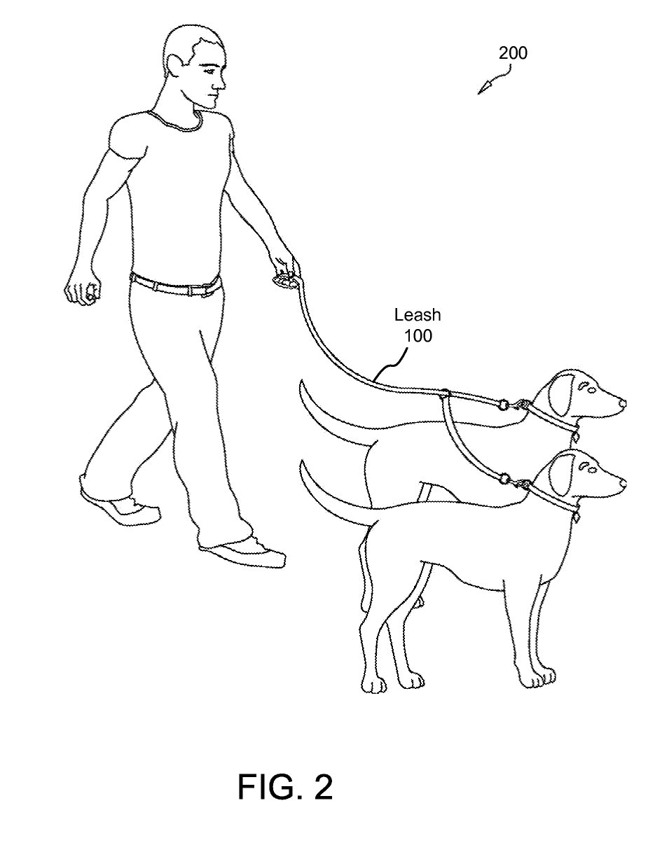

FIG. 2 is an environmental perspective view of an adjustable leash 200 for a plurality of canines in accordance with the present invention.

The leash 200 is used as shown.

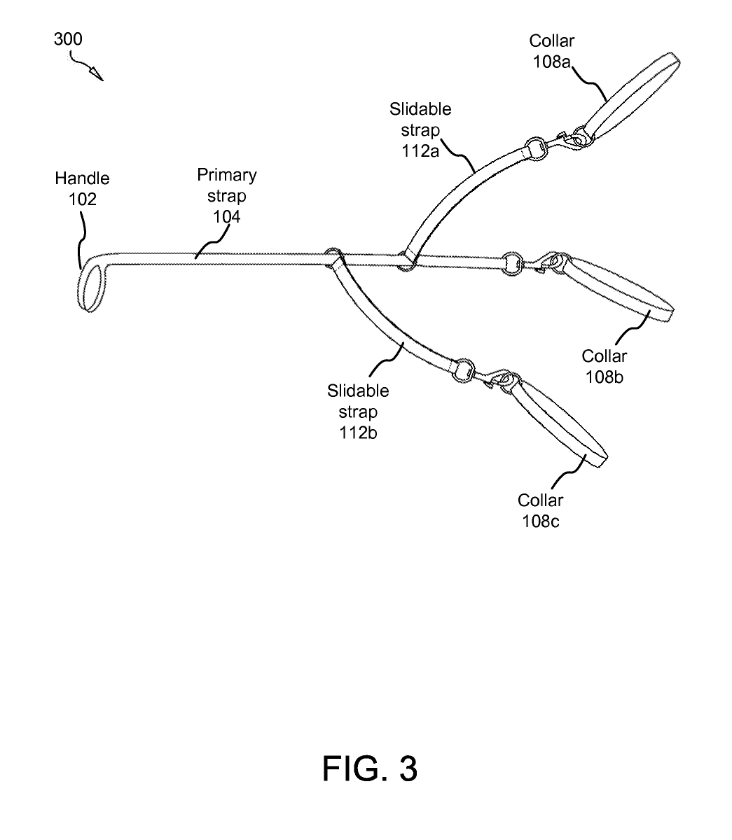

FIG. 3 is an elevational perspective view of an adjustable leash 300 for a plurality of canines in accordance with the present invention. The leash 300 comprises a handle 102, a primary 104, a collar 108a, a collar 108b, a collar 108c, a slidable strap 112a, and slidable strap 112b.

Each of the handle 102, a primary 104, collars 108a-b, slidable strap 112a-b are all substantially described above in relation to FIG. 1.

FIG. 3 includes an additional slidable strap 112a, and is meant to illustrate embodiments of the present invention which include a plurality of slidable straps 112. The present invention may include configurations of up to six slidable straps 112, each strap slidably connecting with a d-ring, swivel clip, or the like to the primary strap 104.

In some embodiments of the present invention, the invention comprises a leash extension strap (i.e. a slidable strap 112 and its components) which is detachably affixable to a leash manufactured by another party.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A leash for restraining a plurality of dogs, the leash comprising:
an elongated flexible primary strap comprising a handle at a proximal end and a detachable connector at a distal end for clipping to a dog collar; and
one or more elongated flexible slidable straps comprising a d-ring at a proximal end and detachable connector at a distal end for clipping to a dog collar, wherein the d-ring is slidably affixed to the primary strap such that slidable strap slides between the distal and the proximal ends of the primary strap.

2. The leash of claim 1, wherein each detachable connector comprises a snap shackle.

3. The leash of claim 1, wherein each detachable connector comprises a swivel clip.

4. The leash of claim 1, further comprising one or more dog collars, each collar affixed to one of the primary strap and the slidable strap.

5. The leash of claim 1, further comprising a d-ring interconnecting the detachable connector and the slidable strap.

6. The leash of claim 1, wherein the primary strap and the slidable strap(s) each are fabricated from one of leather, polymers, chain, rope, and cable.

7. A leash for restraining a plurality of dogs, the leash comprising:
an elongated flexible primary strap comprising a handle at a proximal end and a swivel clip at a distal end for clipping to a dog collar; and
a plurality of elongated flexible slidable straps, each slidable strap comprising a detachable connector at a proximal end and swivel clip at a distal end for clipping to a dog collar, wherein the detachable connector is slidably affixed to the primary strap such that slidable strap slides between the distal and the proximal ends of the primary strap; wherein each slidable strap is detachable from the primary strap.

8. The leash of claim 7, further comprising a plurality of dog collars, each collar affixed to one of the primary strap and a slidable strap.

9. The leash of claim 7, wherein the primary strap and the slidable strap(s) each are fabricated from one of leather, polymers, chain, rope, and cable.

10. A leash extension strap for restraining a second dog to a dog leash, the leash extension strap comprising:
an elongated flexible slidable strap comprising a detachable connector at a proximal end for clipping to a leash and swivel clip at a distal end for clipping to a dog collar, wherein the detachable connector is slidably affixed to the leash such that extension strap slides between a distal end and a proximal end of the leash.
